(19) United States
(12) Patent Application Publication
(10) Pub. No.: US 2015/0239401 A1
(43) Pub. Date: Aug. 27, 2015

(54) Gas Tank Door and Hand Cleaner Combination

(71) Applicant: Adam J. Drake, Sunrise, FL (US)

(72) Inventor: Adam J. Drake, Sunrise, FL (US)

(21) Appl. No.: 14/190,302

(22) Filed: Feb. 26, 2014

(51) Int. Cl. B60R 7/08; B60K 15/04

(52) U.S. Cl. CPC B60R 7/084; B60K 15/04; B60R 7/08; B60K 2015/0458

(57) ABSTRACT

A gas tank cover and hand cleaner combination includes a fuel well of a vehicle has a gas tank cap positioned therein. A door is pivotally coupled to the fuel well and the door has an interior surface. A housing has a front wall, a back wall and a perimeter wall attached to and extending between front and back walls. An adhesive is positioned on the back wall and secures the housing to the interior surface. A plurality of towelettes is positioned within the housing. Each of the towelettes is impregnated with a cleansing fluid. The front wall has an opening therein so that the towelettes are individually removable from the housing through the opening.

### BACKGROUND OF THE DISCLOSURE

### Field of the Disclosure

The disclosure relates to hand cleaning systems and more particularly pertains to a new hand cleaning system for providing means for a person clean their hands after fueling a vehicle.

### SUMMARY OF THE DISCLOSURE

An embodiment of the disclosure meets the needs presented above by generally comprising a fuel well of a vehicle has a gas tank cap positioned therein. A door is pivotally coupled to the fuel well and the door has an interior surface. A housing has a front wall, a back wall and a perimeter wall attached to and extending between front and back walls. An adhesive is positioned on the back wall and secures the housing to the interior surface. A plurality of towelettes is positioned within the housing. Each of the towelettes is impregnated with a cleansing fluid. The front wall has an opening therein so that the towelettes are individually removable from the housing through the opening.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front view of a housing for a gas tank cover and hand cleaner combination according to an embodiment of the disclosure.

FIG. 2 is a rear view of the housing of an embodiment of the disclosure.

FIG. 3 is a side view of the housing of an embodiment of the disclosure.

FIG. 4 is a front perspective view of an embodiment of the disclosure.

FIG. 5 is a front perspective view of an embodiment of the disclosure.

### DESCRIPTION OF THE PREFERRED EMBODIMENT

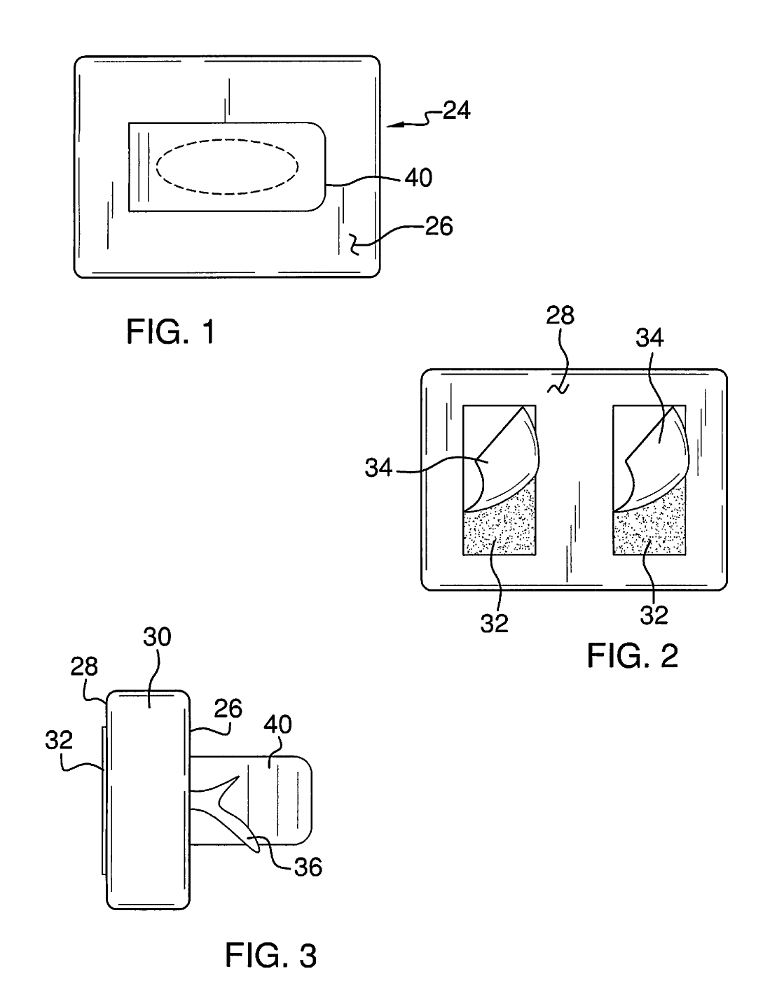

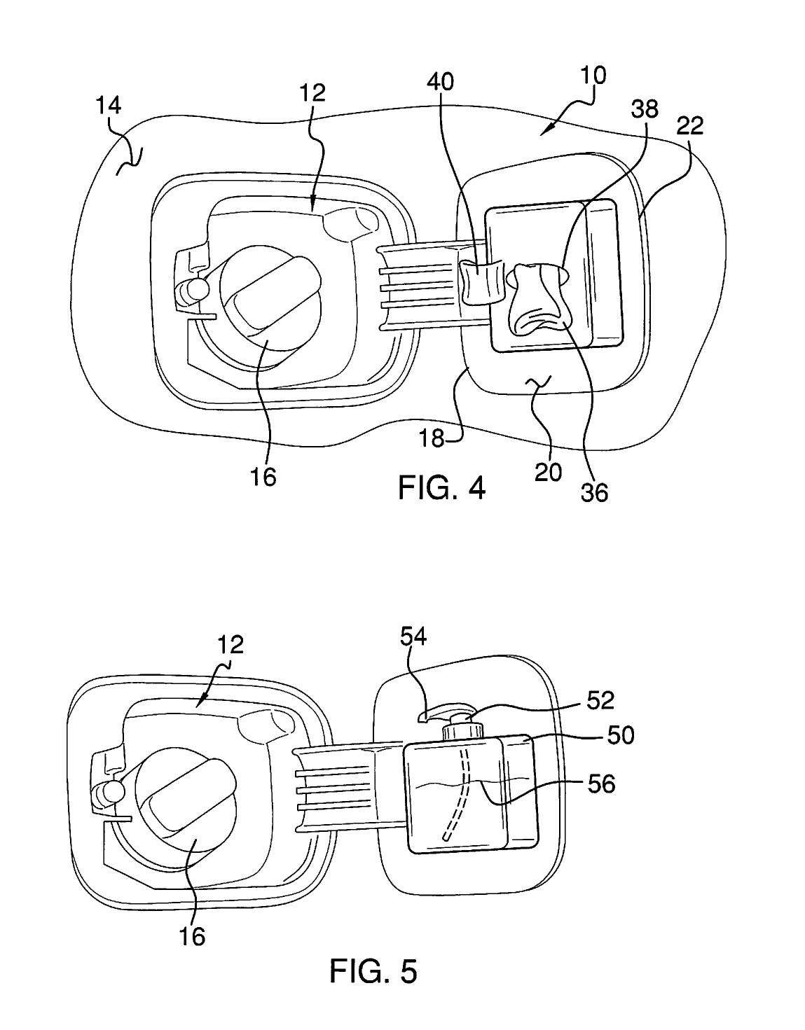

With reference now to the drawings, and in particular to FIGS. 1 through 5 thereof, a new hand cleaning system embodying the principles and concepts of an embodiment of the disclosure and generally designated by the reference numeral 10 will be described.

As best illustrated in FIGS. 1 through 5, the gas tank cover and hand cleaner combination 10 generally comprises a fuel well 12 of a vehicle 14 having a gas tank cap 16 positioned therein. The fuel well 12 and gas tank cap 16 are conventional to vehicles such as cars, trucks, vans and the like. Typically, these devices include a door 18 that is pivotally coupled to the fuel well 12. The door 18 has an interior surface 20 and a perimeter edge 22.

A housing 24 has a front wall 26, a back wall 28 and a perimeter wall 30 that is attached to and extends between front 26 and back 28 walls. The housing 26 may be comprised of any material but in particular may be comprised of a plastic material. The housing 24 has a depth from the front wall 26 to the back wall 28 being less than 3.0 inches. An adhesive 32 is positioned on the back wall 28. The adhesive 30 secures the housing 24 to the interior surface 20 so that the housing 24 is spaced from the perimeter edge 22. The adhesive 32 is may be a pressure sensitive adhesive which may include a removable barrier 34 to prevent its unwanted adhering to objects before use, and which allows the housing 24 to be removed from the door 18. As can be seen in FIG. 2, the adhesive 30 may be provided in multiple strips of adhesive.

A plurality of towelettes 36 is positioned within the housing 24. Each of the towelettes 36 is impregnated with a cleansing fluid to define moistened towelettes and which are conventionally known as “wet wipes.” The towelettes 36 may be comprised of any conventional material used for such wipes, though typically a paper material is used. The front wall 26 has an opening 38 therein and the towelettes 36 are individually removable from the housing 24 through the opening 36. A flexible panel 40 is attached to the front wall 26. The panel 40 is positionable in a closed position covering the opening 36 or in an opened position exposing the opening 36. The panel 40 may be comprised of a material configured to frictionally, adhesively or statically engage the housing 12 when in the closed position. Mechanical fasteners, such as hook and loop fasteners, may also be employed with the panel 40.

The embodiment shown in FIG. 5 includes a housing 50 without the opening 38 or towelettes 36, but may instead include a cleansing fluid 56, configured for cleaning a person's hands, which is positioned within the housing 50. This housing 50 may be attached with adhesive 32 as stated above. A pump 52 is fluidly coupled to the housing 50 and the pump 52 includes a nozzle 54. The cleaning fluid 56 is dispensed from the nozzle 54 when the pump 52 is actuated.

In use, the combination 10 allows a person to clean their hands, particular of fuel, after filling a vehicle 12 with the fuel. Often the manipulation of the fuel cap 16 or the fuel pump leaves fuel residue on the user's hands. The fuel typically has a strong and unpleasant odor. The towelettes 36 or cleansing fluid 56 may be used to remove the fuel. The cleansing fluid 56, which may be positioned on the towelettes 36 or dispensed with the pump 52, may further be scented to assist in masking the odor of the fuel.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. A hand cleaning system configured to facilitate cleaning of a person's hands after the person has put fuel in a vehicle, said system including:
a fuel well of a vehicle having a gas tank cap positioned therein;
a door being pivotally coupled to said fuel well, said door having an interior surface;
a housing having a front wall, a back wall and a perimeter wall being attached to and extending between front and back walls;
an adhesive being positioned on said back wall, said adhesive securing said housing to said interior surface;
a plurality of towelettes being positioned within said housing, each of said towelettes being impregnated with a cleansing fluid to define moistened towelettes; and
said front wall having an opening therein, said towelettes being individually removable from said housing through said opening.

2. A hand cleaning system configured to facilitate cleaning of a person's hands after the person has put fuel in a vehicle, said system including:
a fuel well of a vehicle having a gas tank cap positioned therein;
a door being pivotally coupled to said fuel well, said door having an interior surface and a perimeter edge;
a housing having a front wall, a back wall and a perimeter wall being attached to and extending between front and back walls;
an adhesive being positioned on said back wall, said adhesive securing said housing to said interior surface, said housing being spaced from said perimeter edge;
a plurality of towelettes being positioned within said housing, each of said towelettes being impregnated with a cleansing fluid to define moistened towelettes;
said front wall having an opening therein, said towelettes being individually removable from said housing through said opening; and
a flexible panel being attached to said front wall, said panel being positionable in a closed position covering said opening or in an opened position exposing said opening.

3. A hand cleaning system configured to facilitate cleaning of a person's hands after the person has put fuel in a vehicle, said system including:
a fuel well of a vehicle having a gas tank cap positioned therein;
a door being pivotally coupled to said fuel well, said door having an interior surface;
a housing having a front wall, a back wall and a perimeter wall being attached to and extending between front and back walls;
an adhesive being positioned on said back wall, said adhesive securing said housing to said interior surface, said housing being spaced from said perimeter edge;
a cleansing fluid configured for cleaning a person's hands being positioned within said housing;
a pump being fluidly coupled to said housing, said pump including a nozzle, said cleaning fluid being dispensed from said nozzle when said pump is actuated.
